(19) United States
(12) Patent Application Publication
(10) Pub. No.: US 2025/0327343 A1
(43) Pub. Date: Oct. 23, 2025

(54) Handle System, Handle Assembly, and Anti-Freeze Method for Handle

(71) Applicant: Illinois Tool Works Inc., Glenview, IL (US)

(72) Inventor: Kangxi Ning, Shanghai (CN)

(21) Appl. No.: 19/182,793

(22) Filed: Apr. 18, 2025

(30) Foreign Application Priority Data
Apr. 19, 2024 (CN) 202410479763.2

(51) Int. Cl. E05B 77/34; B60H 1/00

(52) U.S. Cl. CPC E05B 77/34; B60H 1/00271; B60H 2001/003

(57) ABSTRACT

The present disclosure discloses a handle system, a handle assembly, and an anti-freeze method for a handle. The handle system includes a base, a handle, and an anti-freeze control unit. The base defines a base cavity. The handle is arranged in the base cavity, and a ventilation space is provided between the base and an outer periphery of the handle. The anti-freeze control unit allows a gas to enter the ventilation space according to environmental information that determines whether freezing will occur, so as to prevent the handle from being frozen. The anti-freeze control unit of the handle system of the present disclosure controls the gas to enter the ventilation space surrounding the handle according to the environmental information that determines whether freezing will occur, so as to prevent the handle from being frozen. The environmental information that determines whether freezing will occur includes weather forecast, thereby increasing the likelihood of predicting freezing of the handle to effectively prevent the handle from being frozen.

### RELATED APPLICATION

The present application claims the benefit of Chinese Patent Application No. 202410479763.2, filed Apr. 19, 2024, titled “Handle System, Handle Assembly, and Anti-Freeze Method for Handle,” the contents of which are hereby incorporated by reference.

### BACKGROUND

The present disclosure relates to the field of handles. In the prior art, a handle assembly is arranged on a vehicle sheet metal. A handle is rotatable relative to the vehicle sheet metal. However, in cold environment, the handle is prone to be frozen.

### SUMMARY

The present disclosure relates generally to a handle system, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a handle assembly mounted to a vehicle sheet metal according to a first embodiment of the present disclosure from a first perspective.

FIG. 1B is a perspective view of the handle assembly mounted to the vehicle sheet metal as show in FIG. 1A from a second perspective.

FIG. 1C is an exploded view of the handle assembly and the vehicle sheet metal as shown in FIG. 1A.

FIG. 2 is a cross-sectional view of the handle assembly and the vehicle sheet metal as shown in FIG. 1A along line A-A of FIG. 1A.

FIG. 3 is an explode view of a handle assembly mounted to a vehicle sheet metal according to a second embodiment of the present disclosure.

FIG. 4A is a partial perspective view of a flow guide component 302 shown in FIG. 3 taken along line B-B of FIG. 3.

FIG. 4B is a cross-sectional view of the handle assembly and the vehicle sheet metal shown in FIG. 3 along line B-B of FIG. 3.

FIG. 5 is a cross-sectional view of a handle assembly mounted to a vehicle sheet metal according to a third embodiment of the present disclosure.

FIG. 6 is a schematic diagram of the internal structure of an anti-freeze control unit shown in FIG. 5.

FIG. 7 is a diagram of steps of an anti-freeze method for a handle according to a third embodiment of the present disclosure.

FIGS. 8A-8B are a flow chart of the anti-freeze method for a handle according that shown in FIG. 7.

### DETAILED DESCRIPTION OF EMBODIMENTS

Various specific embodiments of the present disclosure are described below with reference to the drawings which constitute part of this description. It should be understood that although the terms indicating directions, such as “front”, “rear”, “upper”, “lower”, “left” and “right” are used in the present disclosure to describe structural portions and elements in various examples of the present disclosure, these terms are used herein only for ease of description and are determined based on the exemplary orientation shown in the drawings. Since the arrangements in the embodiments disclosed in the present disclosure may be in various directions, these terms indicating directions are only illustrative and should not be considered as limitations. In the following drawings, the same components are denoted by the same reference numerals.

A first aspect of the present disclosure provides a handle system, including a base, a handle, and an anti-freeze control unit. The base defines a base cavity. The handle is arranged in the base cavity, and a ventilation space is provided between the base and an outer periphery of the handle. The anti-freeze control unit is configured to allow a gas to enter the ventilation space according to environmental information that determines whether freezing will occur, so as to prevent the handle from being frozen.

The handle system according to the above first aspect further includes a humidity sensor and a temperature sensor. The humidity sensor is in communication connection with the anti-freeze control unit, and is configured to measure a humidity of the air where the handle is located. The temperature sensor is in communication connection with the anti-freeze control unit, and is configured to measure a temperature of air where the handle is located.

The handle system according to the above first aspect further includes a gas delivery device in communication connection with the anti-freeze control unit and configured to deliver a gas into the ventilation space. The anti-freeze control unit is configured to control activation and deactivation of the gas delivery device.

According to the handle system according to the above first aspect, the gas delivery device is an air-conditioning device of a vehicle or an air pump independent of the air-conditioning device of the vehicle.

According to the handle system according to the above first aspect, the gas delivery device is configured to be activated at predetermined time intervals to deliver gas to a space at the outer periphery of the handle.

The handle system according to the above first aspect further includes a heating component in communication connection with the anti-freeze control unit and configured to heat the gas, so that the heated gas enters the ventilation space.

According to the handle system according to the above first aspect, the environmental information on whether freezing will occur includes a humidity of air where the handle is located, rain or snowfall for that day from weather forecast, and a temperature of the air where the handle is located.

According to the handle system according to the above first aspect, the base includes a peripheral wall arranged around the outer periphery of the handle and a bottom wall arranged on an inner side of the handle, the bottom wall of the base is provided with a ventilation channel, and the ventilation channel is in fluid communication with the ventilation space, so that the gas enters the ventilation space through the ventilation channel.

The handle system according to the above first aspect further includes a flow guide component, where the flow guide component is arranged in the base cavity, at least partially extends into the ventilation space, and surrounds at least part of the outer periphery of the handle. The flow guide component defines a flow guide cavity and has an inlet and at least one first outlet, the inlet and the at least one first outlet being in communication with the flow guide cavity, and the first outlet being located in the ventilation space. The inlet is in communication with the ventilation channel, and the at least one first outlet is arranged toward the ventilation space, so that the gas ejected from the ventilation channel is capable of entering the ventilation space through the flow guide component.

According to the handle system according to the above first aspect, the handle has an outer handle surface, and the at least one first outlet surrounds at least part of the outer periphery of the handle and is configured such that a ventilation direction of the first outlet is perpendicular to the outer handle surface, so that the gas blown out of the first outlet moves substantially perpendicular to the outer handle surface.

According to the handle system according to the above first aspect, the flow guide component has at least one second outlet, the at least one second outlet surrounding at least part of the outer periphery of the handle and being located in the ventilation space. The at least one second outlet is configured such that a ventilation direction of the second outlet is inclined to the outer handle surface, so that the gas blown out from the first outlet moves toward the handle.

According to the handle system according to the above first aspect, the flow guide component includes a guide portion arranged around the handle, the guide portion being arranged inclined to the outer handle surface and configured to guide the handle to move relative to the base. The at least one second outlet is arranged on the guide portion.

A second aspect of the present disclosure provides a handle assembly, including a base and a handle. The base defines a base cavity. The handle is arranged in the base cavity, and a ventilation space is provided between the base and an outer periphery of the handle. The base includes a peripheral wall arranged around the outer periphery of the handle and a bottom wall arranged on an inner side of the handle, the bottom wall of the base is provided with a ventilation channel, and the ventilation channel is in fluid communication with the ventilation space, so that the gas enters the ventilation space through the ventilation channel.

The handle assembly according to the above second aspect further includes a flow guide component, where the flow guide component is arranged in the base cavity, at least partially extends into the ventilation space, and surrounds at least part of the outer periphery of the handle; and the flow guide component defines a flow guide cavity and has an inlet and at least one first outlet, the inlet and the at least one first outlet being in communication with the flow guide cavity, and the first outlet being located in the ventilation space. The inlet is in communication with the ventilation channel, and the at least one first outlet is arranged toward the ventilation space, so that the gas blown out from the ventilation channel is capable of entering the ventilation space through the flow guide component.

According to the handle assembly according to the above second aspect, the handle has an outer handle surface, and the at least one first outlet surrounds at least part of the outer periphery of the handle and is configured such that a ventilation direction of the first outlet is perpendicular to the outer handle surface, so that the gas ejected from the first outlet moves substantially perpendicular to the outer handle surface.

According to the handle assembly according to the above second aspect, the flow guide component has at least one second outlet, the at least one second outlet surrounding at least part of the outer periphery of the handle and being configured such that a ventilation direction of the second outlet is inclined to the outer handle surface, so that the gas ejected from the first outlet moves toward the handle.

According to the handle assembly according to the above second aspect, the flow guide component includes a guide portion arranged around the handle, and the guide portion is arranged inclined to the outer handle surface and is configured to guide the handle to move relative to the base. The at least one second outlet is arranged on the guide portion.

According to the handle assembly according to the above second aspect, the gas originates from an air conditioning system of a vehicle or an air pump independent of the air conditioning system of the vehicle.

The handle assembly according to the above second aspect further includes a heating component arranged in the flow guide cavity and configured to heat the gas in the flow guide cavity.

A third aspect of the present disclosure provides an anti-freeze method for a handle, the method including: a step S01 of acquiring environmental information that determines whether freezing will occur; a step S02 of determining whether the handle will be frozen according to the environmental information that determines whether freezing will occur; and a step S03 of ventilating, when it is determined that the handle will be frozen according to the environmental information that determines whether freezing will occur, a space at an outer periphery of the handle, so as to prevent the handle from being frozen.

According to the anti-freeze method for a handle according to the above third aspect, the environmental information that determines whether freezing will occur comprises a humidity of air where the handle is located, rain or snowfall for that day from weather forecast, and a temperature of the air where the handle is located.

According to the anti-freeze method for a handle according to the above third aspect, step S02 includes the following step: determining that the handle will be frozen when the humidity of the air where the handle is located is greater than a preset air humidity or rain or snowfall is predicted for that day from weather forecast, and the temperature of the air where the handle is located is less than a freezing temperature.

According to the anti-freeze method for a handle according to the above third aspect, step S03 includes the following steps: a step S31 of sending, when it is determined that the handle will be frozen according to the environmental information that determines whether freezing will occur, an anti-freeze activating confirmation information to a user; and a step S32 of ventilating, when the user does not prevent the activation of anti-freeze, the space at the outer periphery of the handle.

According to the anti-freeze method for a handle according to the above third aspect, step S03 includes the following steps: a step S41 of determining whether a temperature of air where the handle is located is less than a freezing temperature; a step S42 of delivering, when the temperature of the air where the handle is located is greater than or equal to the freezing temperature, normal temperature air to the space at the outer periphery of the handle; and a step S43 of delivering, when the temperature of the air where the handle is located is less than the freezing temperature, hot air to the space at the outer periphery of the handle.

A fourth aspect of the present disclosure provides an anti-freeze method for a handle for controlling the handle system or the handle assembly as described above.

The anti-freeze control unit of the handle system of the present disclosure controls the gas to enter the ventilation space surrounding the handle according to the environmental information that determines whether freezing will occur, so as to prevent the handle from being frozen. The environmental information that determines whether freezing will occur includes weather forecast, thereby increasing the likelihood of predicting freezing of the handle to effectively prevent the handle from being frozen.

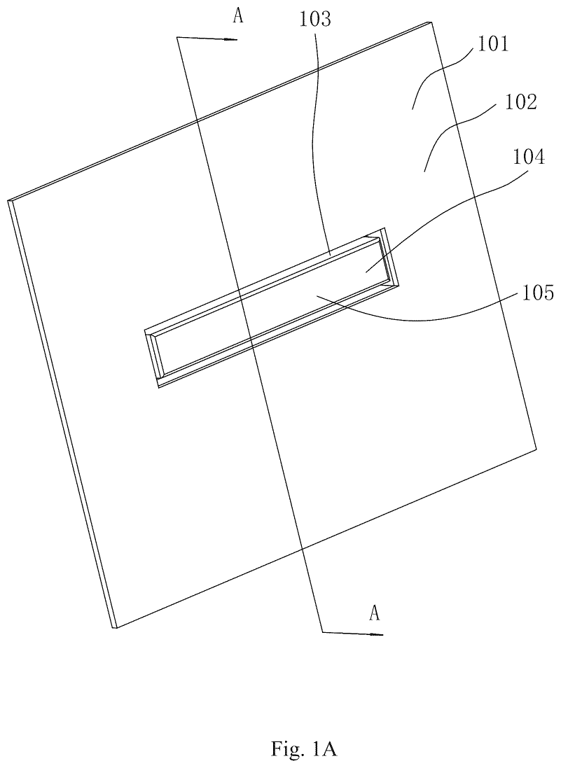

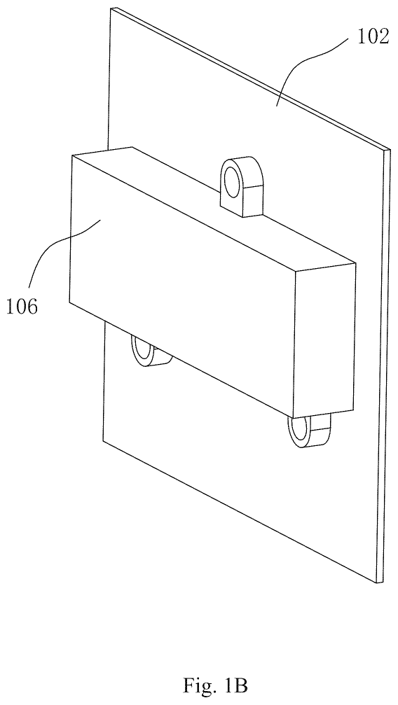

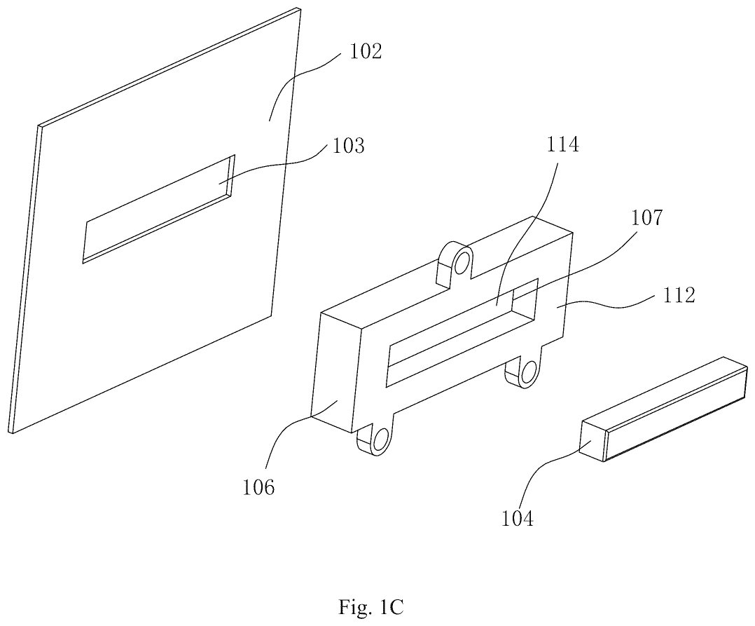

FIG. 1A is a perspective view of a handle assembly mounted to a vehicle sheet metal according to a first embodiment of the present disclosure from a first perspective. FIG. 1B is a perspective view of the handle assembly mounted to the vehicle sheet metal as shown in FIG. 1A from a second perspective. FIG. 1C is an exploded view of the handle assembly and the vehicle sheet metal as shown in FIG. 1A. As shown in FIGS. 1A-1C, the handle assembly is mounted to the vehicle sheet metal 102. A sheet metal through hole 103 is provided in the vehicle sheet metal 102, the sheet metal through hole is provided through a thickness of the vehicle sheet metal 102. The handle assembly includes a handle 104 and a base 106. The base 106 defines a base cavity 107. The base cavity 107 is formed by recessing inwardly from a right surface of the base 106, so as to accommodate the handle 104. The handle 104 can be accommodated in the base cavity 107 and move relative to the base 106. The handle 104 has a closed position and an open position. The handle 104 is in the closed position when a vehicle is running. The handle 104 is in the open position when the vehicle is parked. As an example, the handle 104 can make a translational movement relative to the base 106. As an example, the base 106 is arranged on a side of the vehicle sheet metal 102. When the base 106 is mounted in position on the vehicle sheet metal 102 and the handle 104 is in the closed position, a generally planar outer handle surface 105 of the handle 104 is generally flush with an outer surface 101 of the vehicle sheet metal 102. When the base 106 is mounted in position on the vehicle sheet metal and the handle 104 is in the open position, the outer handle surface 105 of the handle 104 protrudes from the outer surface 101 of the vehicle sheet metal 102.

As shown in FIG. 1A, when the handle 104 is in the closed position, there is an annular gap between the base 106 and the outer periphery of the handle 104 to form the ventilation space 103. More specifically, as shown in FIGS. 1C, the base 106 includes a peripheral wall 112 and a bottom wall 114. The peripheral wall 112 is disposed around the outer periphery of the handle 104, and the bottom wall 114 is disposed inside of the handle 104. A ventilation channel is provided in the base 106 so that a gas can enter the ventilation space 103 through ventilation channel. The gas entering the ventilation space 103 can prevent the handle 104 from being frozen.

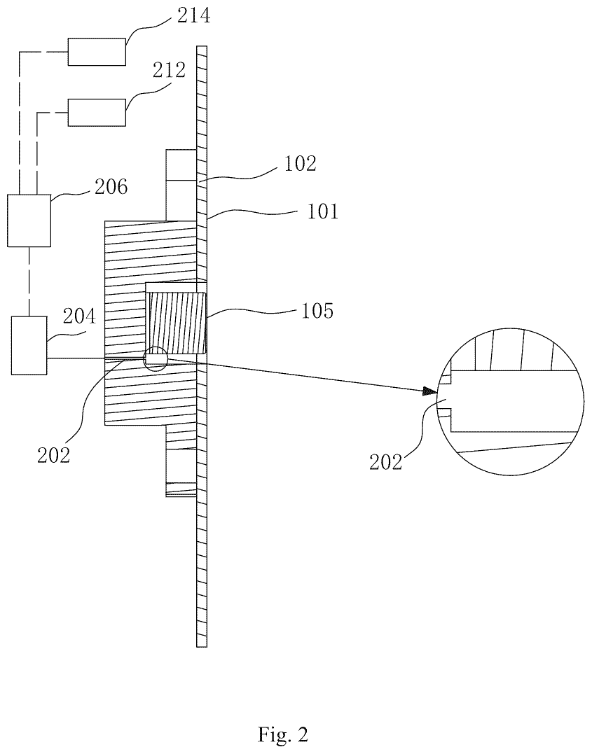

FIG. 2 is a cross-sectional view of the handle assembly and the vehicle sheet metal as shown in FIG. 1A along line A-A of FIG. 1A to illustrate one embodiment of the ventilation channel. As shown in FIG. 2, a ventilation channel 202 is provided in the bottom wall 114 of the base 106. Specifically, the ventilation channel 202 extends through the bottom wall 114 in a thickness direction of the bottom wall 114. The ventilation channel 202 is in communication with the ventilation space 103 so that the gas can enter the ventilation space 103 through the ventilation channel 202.

FIG. 2 also shows a schematic view of a handle system including various components of the handle assembly of the first embodiment described above. As shown in FIG. 2, the handle system further includes a gas delivery device 204 and an anti-freeze control unit 206. The gas delivery device 204 is in communication connection with the anti-freeze control unit 206, and is configured to deliver a gas into the ventilation space 103. The anti-freeze control unit 206 is configured to control activation and deactivation of the gas delivery device 204. As one embodiment, the gas delivery device 204 is an air-conditioning device of a vehicle in which the handle assembly is located. That is, the air-conditioning device that provides an air-conditioning flow to the vehicle also provides a gas to the ventilation space 103. Furthermore, since the temperature of the gas sent out from the air-conditioning device is adjustable, the gas delivery device 204 can provide a gas warmer than the ambient temperature, thereby preventing the handle 104 from being frozen. As another embodiment, the gas delivery device 204 is an air pump independent of the air-conditioning device of the vehicle in which the handle assembly is located. The air pump can provide a gas having the ambient temperature, and the gas flows in the ventilation space 103 and is blown out of the vehicle sheet metal, thereby preventing a liquid from condensing on a surface of the handle 104 which will freeze the handle 104. The gas delivery device 204 is configured to be capable of being activated continuously or at predetermined intervals (i.e., intermittently) to provide the gas to the ventilation space 103. As an embodiment, the predetermined interval is 10 seconds. That is, the gas delivery device 204 provides the gas to the ventilation space 103 for 10 seconds, stops for 10 seconds, and is then activated again.

As shown in FIG. 2, the handle system further includes a humidity sensor 212 and a temperature sensor 214. The humidity sensor 212 is in communication connection with the anti-freeze control unit 206, and is configured to measure a humidity of air where the handle 104 is located. The temperature sensor 214 is in communication connection with the anti-freeze control unit 206, and is configured to measure a temperature of the air where the handle 104 is located. The humidity sensor 212 and the temperature sensor 214 can send currently obtained air humidity and air temperature to the anti-freeze control unit 206. The anti-freeze control unit 206 is configured to determine whether the handle 104 is frozen based on the environmental information including the air humidity and the air temperature, thereby controlling the activation and deactivation of the gas delivery device 204.

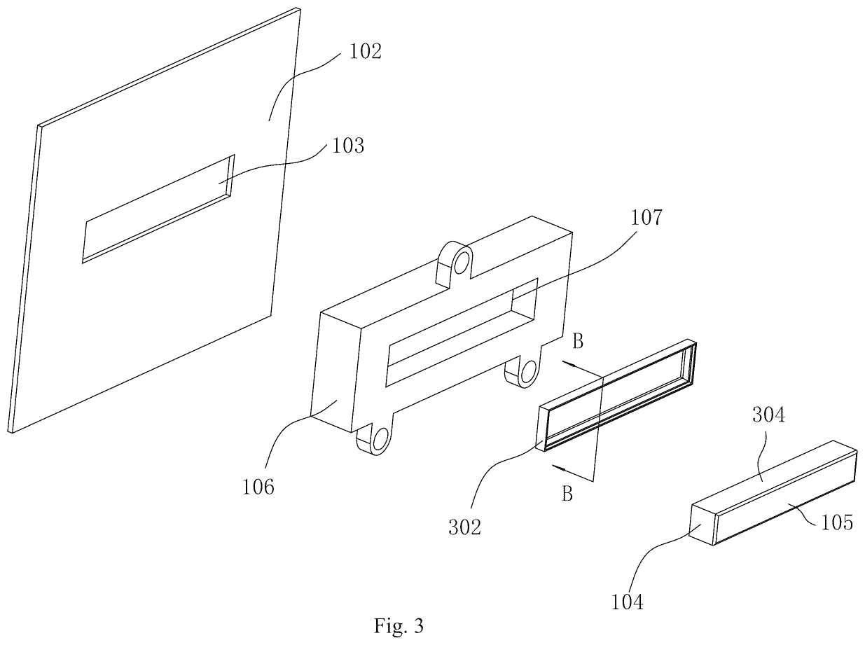

FIG. 3 is an explode view of a handle assembly mounted to a vehicle sheet metal according to a second embodiment of the present disclosure. The similarities between the handle assembly of the second embodiment shown in FIG. 3 and the handle assembly of the first embodiment shown in FIG. 1A are not described again, the difference lies in, the handle assembly of the second embodiment shown in FIG. 3 further includes a flow guide component 302. The flow guide component 302 is generally frame-shaped and is configured to guide the gas blown out from the ventilation channel 202. The flow guide component 302 is arranged in the base cavity 107, at least partially extends into the ventilation space 103, and surrounds the outer periphery of the handle 104.

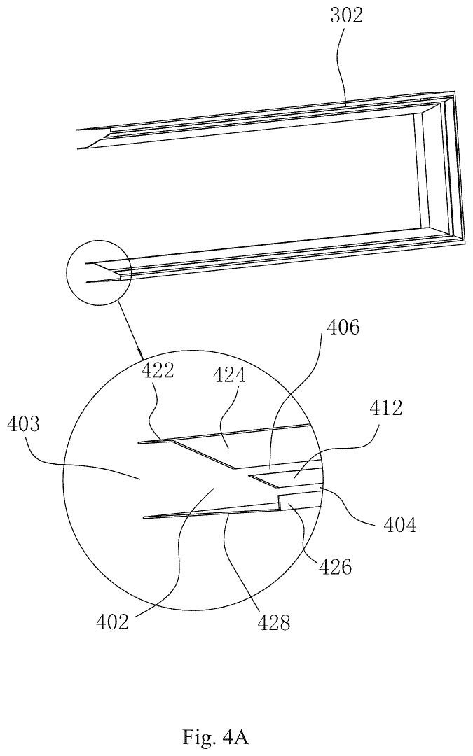

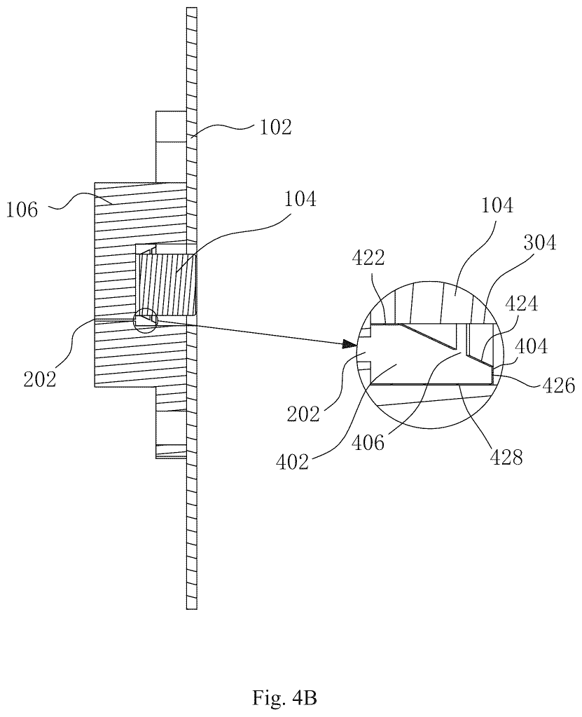

FIG. 4A is a partial perspective view of the flow guide component 302 shown in FIG. 3 along line B-B of FIG. 3, and FIG. 4B is a cross-sectional view of the handle assembly and the vehicle sheet metal shown in FIG. 3 along line B-B of FIG. 3. As shown in FIGS. 4A-4B, the flow guide component 302 defines a flow guide cavity 402 and has an inlet 403, a first outlet 404 and a second outlet 406. The inlet 403, the first outlet 404 and the second outlet 406 are each in communication with the flow guide cavity 402. The first outlet 404 and the second outlet 406 are located in the ventilation space 103. The inlet 403 is in communication with the ventilation channel 202, and the first outlet 404 and the second outlet 406 are arranged toward the ventilation space 103, so that the gas blown out from the ventilation channel 202 can enter the ventilation space 103 through the flow guide component 302. Specifically, the flow guide component 302 includes an inner frame 422, an inclined frame 424, a vertical frame 426, and an outer frame 428. Each of the inner frame 422, the inclined frame 424, the vertical frame 426 and the outer frame 428 is generally in the form of a rectangular frame. The inner frame 422 and the outer frame 428 are arranged in parallel, and the outer frame 428 surrounds the inner frame 422. Any side of the inner frame 422 and the outer frame 428 is generally parallel to the outer handle surface 105 of the handle 104. The inner frame 422 encloses a space that is slightly larger than a size of the handle 104, allowing the handle 104 to be accommodated within the space enclosed by the inner frame 422. The inner frame 422 is arranged at a distance from the outer frame 428 to form the inlet 403. The inlet 403 is in communication with the ventilation channel 202 so that the gas can enter the flow guide cavity 402. The inclined frame 424 is arranged at an angle to the outer handle surface 105 of the handle 104 and is connected to the inner frame 422. The inclined frame 424 forms a guide portion 412. The guide portion 412 is located in the ventilation space 103 and is configured to guide the movement of the handle 104 relative to the base 106. Specifically, when the handle 104 is moved from the open position toward the closed position, the handle 104 translate toward the base 106 relative to the base 106. During the movement, the handle 104 may contact the guide portion 412 at an edge to follow the guide portion 412 to move toward the base 106, and finally enters the space enclosed by the inner frame 422 and is held in position. The second outlet 406 is provided on the guide portion 412 and surrounds the outer periphery of the handle 104. The second outlet 406 has an air deliver direction at an angle to the outer handle surface 105 of the handle 104 and is configured such that when the handle 104 is in the closed position, the gas blown out from the second outlet 406 can be blown onto a sidewall 304 of the handle 104 that is substantially perpendicular to the outer handle surface 105 (see FIG. 3). The vertical frame 426 is arranged generally perpendicular to the outer handle surface 105 of the handle 104 and is connected to the outer frame 428 and the inclined frame 424. The first outlet 404 is provided on the vertical frame 426 and surrounds the outer periphery of the handle 104. The first outlet 404 has an air deliver direction perpendicular to the outer handle surface 105 of the handle 104 and is configured to enable the gas blown out of the first outlet 404 to move substantially perpendicular to the outer handle surface 105.

It should be noted that while the first outlet 404 and the second outlet 406 are provided on the flow guide component 302 of the present disclosure, in other embodiments, no second outlet 406 may be provided.

It should be noted that while one first outlet 404 and one second outlet 406 are provided on the flow guide component 302 of the present disclosure, and both the first outlet 404 and the second outlet 406 are annular elongated openings, in other embodiments, at least two first outlets 404 and at least two second outlets 406 may be provided on the flow guide component 302, the at least two first outlets 404 may be spaced apart so as to surround at least part of the outer periphery of the handle 104. At least two second outlets 406 may be spaced apart so as to surround at least part of the outer periphery of the handle 104.

It should be noted that while the flow guide component 302 of the present disclosure is provided in the ventilation space 103 and surrounds the outer periphery of the handle 104, in other embodiments, the flow guide components 302 may be provided in sections so as to surround part of the outer periphery of the handle 104 and extend partially into the ventilation space 103 as long as the outlets (e.g., the first outlet 404 and the second outlet 406) are located in the ventilation space 103.

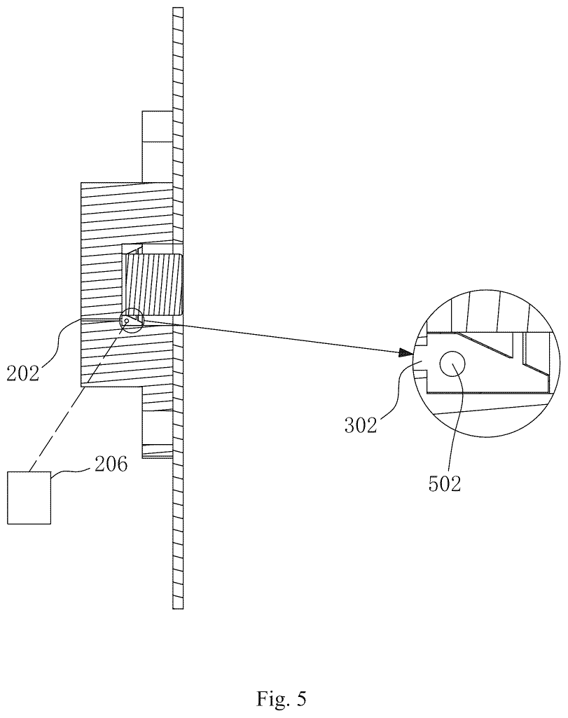

FIG. 5 is a cross-sectional view of a handle assembly mounted to a vehicle sheet metal according to a third embodiment of the present disclosure. The similarities between the handle assembly of the third embodiment shown in FIG. 5 and the handle assembly of the second embodiment shown in FIG. 3 are not described again, the difference les in, the gas delivery device 204 of the handle assembly of the third embodiment shown in FIG. 5 is an air pump independent of the air-conditioning device of the vehicle, and the handle assembly further includes a heating component 502. The heating component 502 is in communication connection with the anti-freeze control unit 206, and is configured to heat the gas, so that the heated gas enters the ventilation space 103.

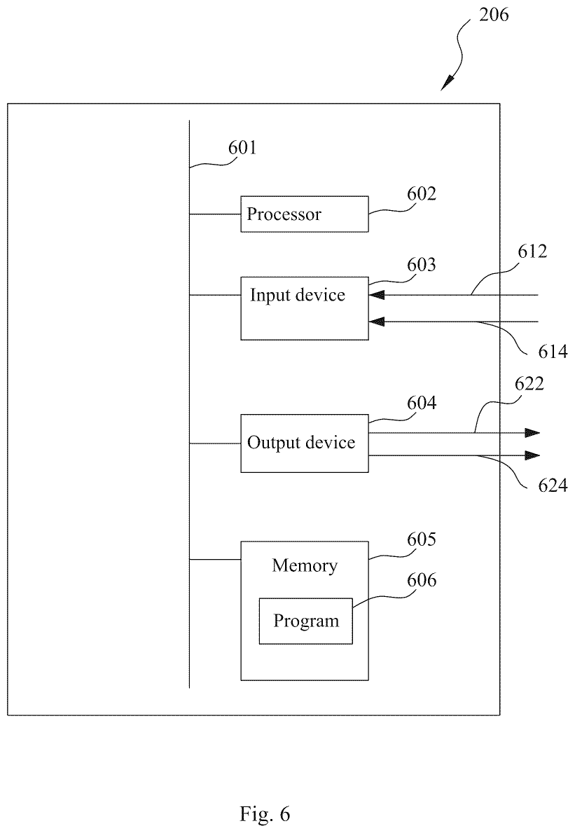

FIG. 6 is a schematic diagram of the internal structure of the anti-freeze control unit 206 shown in FIG. 5. As shown in FIG. 6, the anti-freeze control unit 206 includes a bus 601, a processor 602, an input device 603, an output device 604, and a memory 605 having a control program 606. The various components of the anti-freeze control unit 206, including the processor 602, the input device 603, the output device 604 and the memory 605, are communicatively connected to the bus 601, such that the processor 602 can control the operations of the input device 603, the output device 604 and the memory 605. Specifically, the memory 605 is configured to store programs, instructions and data, and the processor 602 reads the programs, instructions and data from the memory 605 and can write data to the memory 605. The processor 602 controls the operations of the input device 603 and the output device 604 by means of executing the programs and the instructions read from the memory 605. The input device 603 receives, via connections 612, 614, external signals and data, including the detected humidity of the air where the handle 104 is located from the humidity sensor 212 and the detected temperature of the air where the handle 104 is located from the temperature sensor 214. The output device 604 sends, via connections 622, 624, control signals to the gas delivery device 204 and the heating component 502, to control the activation and deactivation of the gas delivery device 204 and the activation and deactivation of the heating component 502.

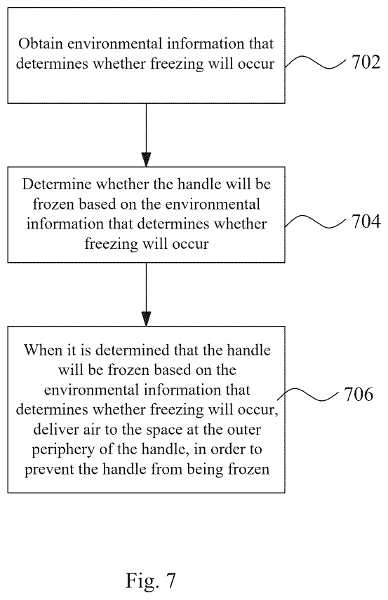

In an embodiment of the present disclosure, a program for implementing the flow chart shown in FIG. 7 is stored in the memory 605 of the anti-freeze control unit 206. The program stored in the anti-freeze control unit 206 is executed by the processor 602, and the anti-freeze control unit 206 controls the gas delivery device 204 and the heating component 502.

FIG. 7 is a diagram of steps of an anti-freeze method for a handle according to a third embodiment of the present disclosure. As shown in FIG. 7, in step 702, the processor 602 obtains environmental information that determines whether freezing will occur. The environmental information that determines whether freezing will occur includes a humidity of air where the handle is located, rain or snowfall for that day from weather forecast, and a temperature of the air where the handle is located. In step 704, the processor 602 determines whether the handle will be frozen based on the environmental information that determines whether freezing will occur. In step 706, when it is determined that the handle will be frozen based on the environmental information that determines whether freezing will occur, the processor 602 controls the gas delivery device 204 and the heating component 502 to deliver air to the space at the outer periphery of the handle, to prevent the handle from being frozen.

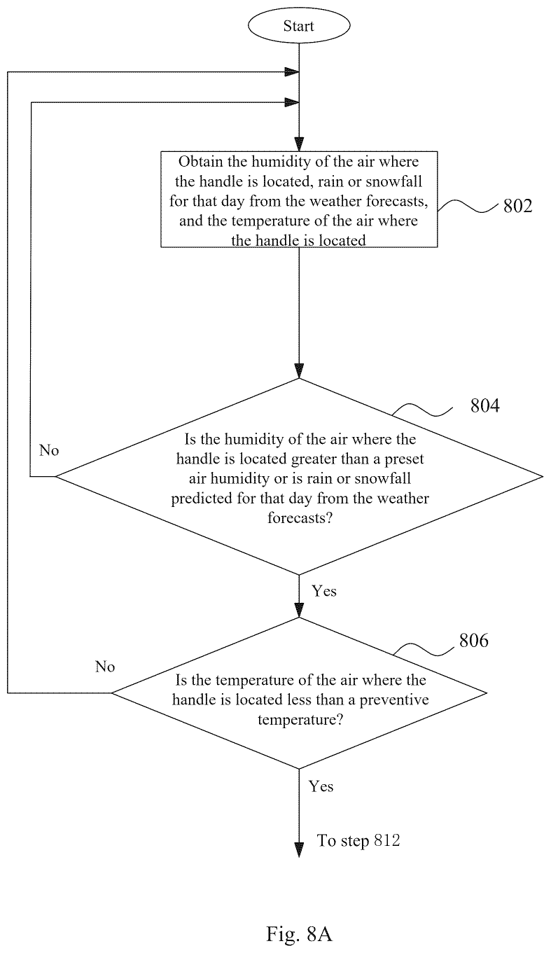

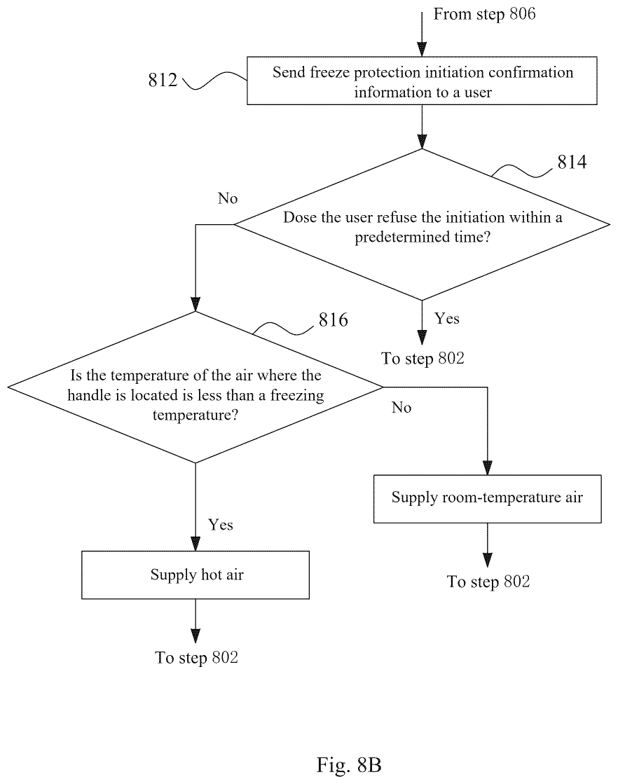

FIGS. 8A-8B are flow charts of the anti-freeze method for a handle according shown in FIG. 7. As shown in FIGS. 8A-8B, in step 802, the processor 602 obtains the detected humidity of the air where the handle 104 is located from the humidity sensor 212, the detected temperature of the air where the handle 104 is located from the temperature sensor 214, and weather forecasts from the network. Subsequently, the processor 602 proceeds the procedure to step 804.

In step 804, the processor 602 determines whether the humidity of the air where the handle 104 is located is greater than a preset air humidity, or whether rain or snowfall is predicted for that day from the weather forecasts. As an example, the preset air humidity is 80%. If the humidity of the air where the handle 104 is located is less than or equal to the preset air humidity, or if no rain or snowfall is predicted for that day from the weather forecasts, the processor 602 returns the procedure back to step 802. If the humidity of the air where the handle 104 is located is greater than the preset air humidity, or if rain or snowfall is predicted for that day from the weather forecasts, the processor 602 proceeds the procedure to step 806.

In step 806, the processor 602 determines whether the temperature of the air where the handle 104 is located is less than a preventive temperature. As an example, the preventive temperature is 0° C. In another example, the preventive temperature is −5° C. If the temperature of the air where the handle 104 is located is greater than or equal to the preventive temperature, the processor 602 returns to step 802. If the temperature of the air where the handle 104 is located is less than the preventive temperature, the processor 602 proceeds the procedure to step 802. Thereby, by means of steps 804 and 806, the processor 602 determines whether the handle will be frozen. When the processor 602 determines that the handle will be frozen, the processor 602 returns the procedure back to step 802.

In step 812, the processor 602 sends freeze protection initiation confirmation information to a user. As an example, the anti-freeze control unit 206 is communicatively connected to the user's mobile phone, to send the freeze protection confirmation information to the user's mobile phone for confirmation by the user. Subsequently, the processor 602 proceeds the procedure to step 814.

In step 814, the processor 602 waits for the user to confirm that freeze protection is initiated. When the user prevents the freeze protection from being initiated, the processor 602 returns the procedure to step 802. When the user agrees to initiate the freeze protection, the processor 602 proceeds the procedure to step 816. In one embodiment, when the user does not refuse to initiate the freeze protection within a predetermined time, the processor 602 considers the user to agree to initiate the freeze protection, and the processor 602 will control and activate the gas delivery device 204, so as to deliver air to the space at the outer periphery of the handle 104 (i.e., the ventilation space 103). When the user refuses to initiated the freeze protection within the predetermined time, the processor 602 considers the user to prevent the freeze protection from being initiated. As an example, the predetermined time is 5 minutes.

In step 816, the processor 602 determine whether the temperature of the air where the handle is located is less than a freezing temperature. When the temperature of the air where the handle is located is greater than or equal to the freezing temperature, the processor 602 controls and activates the gas delivery device 204, so as to deliver room-temperature air (i.e., air at room temperature) to the space at the outer periphery of the handle 104. Subsequently, the processor 602 returns the procedure to step 802. When the temperature of the air where the handle is located is less than the freezing temperature, the processor 602 effects to deliver hot air to the space at the outer periphery of the handle 104. In other words, the processor 602 controls and activates the gas delivery device 204 and the heating component 502. Subsequently, the processor 602 returns the procedure to step 802. In one example, the freezing temperature is −10° C. In another example, the freezing temperature is −15° C. In yet another example, the freezing temperature is −25° C.

The handle system of the present disclosure has the anti-freeze control unit, where the anti-freeze control unit controls the gas to enter the ventilation space surrounding the handle according to the environmental information that determines whether freezing will occur, so as to prevent the handle from being frozen. The environmental information that determines whether freezing will occur includes weather forecast, thereby increasing the likelihood of predicting freezing of the handle to effectively prevent the handle from being frozen.

In the handle assembly of the present disclosure, the ventilation channel is provided in the base to deliver air to the ventilation space surrounding the handle to prevent a liquid such as rain/dew from entering the ventilation space, thereby preventing the handle from being frozen.

Although the present disclosure is described with reference to the examples of the embodiments outlined above, various alternatives, modifications, variations, improvements and/or substantial equivalents, which are known or can be anticipated at present or to be anticipated before long, may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to encompass all known or earlier disclosed alternatives, modifications, variations, improvements, and/or substantial equivalents.

What is claimed is:

1. A handle system, comprising:
a base defining a base cavity;
a handle arranged in the base cavity, and a ventilation space is provided between the base and an outer periphery of the handle; and
an anti-freeze control unit configured to allow a gas to enter the ventilation space according to environmental information that determines whether freezing will occur, so as to prevent the handle from being frozen.

2. The handle system according to claim 1, further comprising:
a humidity sensor being in communication connection with the anti-freeze control unit and configured to measure a humidity of air where the handle is located; and
a temperature sensor being in communication connection with the anti-freeze control unit and configured to measure a temperature of the air where the handle is located.

3. The handle system according to claim 1, further comprising:
a gas delivery device being in communication connection with the anti-freeze control unit and configured to deliver a gas into the ventilation space,
wherein the anti-freeze control unit is configured to control activation and deactivation of the gas delivery device.

4. The handle system according to claim 3, wherein
the gas delivery device is an air-conditioning device of a vehicle or an air pump independent of the air-conditioning device of the vehicle.

5. The handle system according to claim 4, wherein
the gas delivery device is configured to be activated at predetermined time intervals to deliver gas to a space at the outer periphery of the handle.

6. The handle system according to claim 5, further comprising:
a heating component being in communication connection with the anti-freeze control unit and configured to heat the gas, so that the heated gas enters the ventilation space.

7. The handle system according to claim 1, wherein
the environmental information on whether freezing will occur comprises a humidity of air where the handle is located, rain or snowfall for that day from weather forecast, and a temperature of the air where the handle is located.

8. The handle system according to claim 1, wherein
the base comprises a peripheral wall arranged around the outer periphery of the handle and a bottom wall arranged on an inner side of the handle, the bottom wall of the base is provided with a ventilation channel, and the ventilation channel is in fluid communication with the ventilation space, so that the gas enters the ventilation space through the ventilation channel.

9. The handle system according to claim 8, further comprising:
a flow guide component arranged in the base cavity, at least partially extending into the ventilation space, and surrounding at least part of the outer periphery of the handle; and
wherein the flow guide component defines a flow guide cavity and has an inlet and at least one first outlet, the inlet and the at least one first outlet are in communication with the flow guide cavity, and the first outlet is located in the ventilation space;
wherein the inlet is in communication with the ventilation channel, and the at least one first outlet is arranged toward the ventilation space, so that the gas ejected from the ventilation channel is capable of entering the ventilation space through the flow guide component.

10. The handle system according to claim 9, wherein
the handle has an outer handle surface, and the at least one first outlet surrounds at least part of the outer periphery of the handle and is configured such that a ventilation direction of the first outlet is perpendicular to the outer handle surface, so that the gas blown out from the first outlet moves substantially perpendicular to the outer handle surface.

11. The handle system according to claim 10, wherein
a flow-directing component has at least one second outlet surrounding at least part of the outer periphery of the handle and being located in the ventilation space; and
the at least one second outlet is configured such that a ventilation direction of the second outlet is inclined to the outer handle surface, so that the gas blown out from the second outlet moves toward the handle.

12. The handle system according to claim 11, wherein
the flow-directing component comprises a guide portion arranged around the handle, and the guide portion is arranged inclined to the outer handle surface and is configured to guide the handle to move relative to the base; and
the at least one second outlet is arranged on the guide portion.

13. A handle assembly, comprising:
a base, defining a base cavity; and
a handle being arranged in the base cavity, and a ventilation space is provided between the base and an outer periphery of the handle;
wherein the base comprises a peripheral wall arranged around the outer periphery of the handle and a bottom wall arranged on an inner side of the handle, the bottom wall of the base is provided with a ventilation channel, and the ventilation channel is in fluid communication with the ventilation space, so that the gas enters the ventilation space through the ventilation channel.

14. The handle assembly according to claim 13, further comprising:
a flow guide component being arranged in the base cavity, at least partially extends into the ventilation space, and surrounds at least part of the outer periphery of the handle; and
the flow guide component defining a flow guide cavity and having an inlet and at least one first outlet, the inlet and the at least one first outlet are in communication with the flow guide cavity, and the first outlet is located in the ventilation space,
wherein the inlet is in communication with the ventilation channel, and the at least one first outlet is arranged toward the ventilation space, so that the gas blown out from the ventilation channel is capable of entering the ventilation space through the flow guide component.

15. The handle assembly according to claim 14, wherein
the handle has an outer handle surface, and the at least one first outlet surrounds at least part of the outer periphery of the handle and is configured such that a ventilation direction of the first outlet is perpendicular to the outer handle surface, so that the gas ejected from the first outlet moves substantially perpendicular to the outer handle surface.

16. The handle assembly according to claim 15, wherein
a flow-directing component has at least one second outlet, and the at least one second outlet surrounds at least part of the outer periphery of the handle and is configured such that a ventilation direction of the second outlet is inclined to the outer handle surface, so that the gas ejected from the second outlet moves toward the handle.

17. The handle assembly according to claim 16, wherein
the flow-directing component comprises a guide portion arranged around the handle, and the guide portion is arranged inclined to the outer handle surface and is configured to guide the handle to move relative to the base; and
the at least one second outlet is arranged on the guide portion.

18. The handle assembly according to claim 13, wherein
the gas originates from an air-conditioning system of a vehicle or an air pump independent of the air-conditioning system of the vehicle.

19. The handle assembly according to claim 14, further comprising:
a heating component being arranged in the flow guide cavity and configured to heat the gas in the flow guide cavity.

20. An anti-freeze method for a handle, the anti-freeze method comprising:
a step S01 of acquiring environmental information that determines whether freezing will occur;
a step S02 of determining whether the handle will be frozen according to the environmental information that determines whether freezing will occur; and
a step S03 of ventilating, when it is determined that the handle will be frozen according to the environmental information that determines whether freezing will occur, a space at an outer periphery of the handle, so as to prevent the handle from being frozen.
